(19) United States
(12) Patent Application Publication
(10) Pub. No.: US 2011/0221200 A1
(43) Pub. Date: Sep. 15, 2011

(54) Two-way generation tidal power plant with bypasses

(76) Inventor: Alexander Gokhman, San Francisco, CA (US)

(21) Appl. No.: 12/932,861

(22) Filed: Mar. 9, 2011

(30) Foreign Application Priority Data
Mar. 9, 2010 (GB) GB 1003836.2

(51) Int. Cl. F03B 13/26

(52) U.S. Cl. 290/53

(57) ABSTRACT

The invention is a two-way generation tidal power plant with bypasses participating in generation. The preferred embodiment of such a tidal power plant has a power house with one-way turbines and additional head and tail reservoirs formed by additional barrages in the basin and the outer bay. The purpose of this invention is to increase the energy production per each tidal cycle and the water volume used for it. The closer this water volume to the water volume filling and emptying the basin under natural conditions without barrage, the smaller is the environmental impact of the tidal power plant. In order to achieve this, the main barrage is equipped with bypasses, the sluices passing water during the final phases of the ebb and the flood generations in parallel to the power house turbines and having a discharge capacity up to 15 times higher than the discharge capacity of the turbines.

### BACKGROUND OF THE INVENTION

This invention relates to tidal power plants (TPP) More specifically, the invention relates to two-way generation tidal power plants with a barrage equipped with one-way hydraulic turbines (TWTPP).

All operating TPP with a barrage generate the power only during ebb. Le Rance in France was built as TWPP plant with barrage and two-way hydraulic turbines, however it cannot work during flood. So at present time still is very important to develop TPP generating the power during ebb and flood. Taking into the account the experience of Le Rance it is easy to see that only TWTPP with a barrage equipped with one-way hydraulic turbines can generate the power during ebb and flood.

Any two-way generation tidal power plant with a barrage and a power house with one-way hydraulic turbines connected to electric generators must have head and tail reservoirs located at the basin and the outer bay, or vice versa, formed by auxiliary barrages and parts of the main barrage. These auxiliary barrages and the parts of the main barrage are equipped with sets of vertical sliding sluices delivering water via the power house, during ebb from the basin to the outer bay and during flood from the outer bay to the basin.

This type of tidal plant was patented in 2008 (“Two-way generation tidal power plant with one-way turbines”, UK Patent, GB 2436857 B, 20.02.2008, Inventor: Alexander Gokhman). It can be seen from the disclosure and claims of this patent that during ebb the sluice sets in auxiliary barrages are open and the sluices in the parts of the main barrage are completely closed (during flood—vice versa). It is also clear that the discharge capacity of each of these sluices sets does not have to be more than two to three times greater than the discharge capacity of all turbines in the power house in order to prevent significant head losses at the inlet to the head reservoir and exit from the tail reservoir.

It is obvious that a plant according to the Patent GB 2436857 is more expensive than an ebb generation tidal power plant having the same number of units. Therefore, this increase of capital investment must be offset by a relative increase in daily energy output:

$${C}_{e} = \frac{{E}_{tw}}{{E}_{ebb}} \qquad ( 1 )$$

where:
E_{tw} is two-way generation plant daily energy output and
E_{ebb} is ebb generation plant daily energy output

In order compute E_{tw}, E_{ebb}, and C_{inc} I developed program (ENERGY) for the solving a well-known nonlinear first order ordinary differential equation:

$$\frac{d {Z}_{b}}{d T} = ∓ \frac{Q ( H )}{{A}_{b} ( {Z}_{b} )} \qquad ( 2 )$$

where:
Z_{b} is the water level in the basin,
T time,
Q(H) is the flow emptying/filling basin as a function of the TWTPP head H, and
A_{b}(Z_{b}) is horizontal cross-sectional area of the TWTPP basin as a function of Z_{b}.
   In equation (2) the sign − is for ebb generation and + for flood generation. The head in (2) is determined by:

H=±(Z_{b}−Zₜ) (3)

where:
Zₜ is the tide level.
   In equation (3) the sign + is for the ebb generation and the sign − is for the flood generation.

The program ENERGY along with the values of E_{tw}, E_{ebb}, and C_{inc} computes the water volumes used for generation during each cycle for ebb TPP, W_{ebu}, and for TWTPP, W_{twu}. It is obvious that the closer W_{twu} and W_{ebu} are to the value of available volume, Wₐᵥₐ, the larger are E_{tw} and E_{ebb}. Also clear that Wᵤₛₑ is larger for larger current turbines discharge capacity at one meter head:

(Q₁)ₚₕ=KₜDₜ²Q₁₁(H) (4)

where:
Kₜ is the number of turbines,
Dₜ is the turbine runner diameter, and
Q₁₁(H) is the current turbine specific flow rate, allowing for cavitation-free and vibration-free work.

The computations of E_{tw}, E_{ebb}, Cₑ, W_{twu}, and W_{ebu} were done for the Cardiff-Weston power house in UK equipped with turbines with Dₜ=7.5 m working at the specific speed, N₁₁=130 rpm, and with turbine efficiency, ηₜ, and cavitation coefficient, σ, as functions of Q₁₁ shown in the following table:

TABLE 1

| Q₁₁ [m³/sec] | 2.8300 | 3.1800 | 3.5300 | 3.8800 | 4.2300 |
|---|---|---|---|---|---|
| ηₜ | 0.9500 | 0.9450 | 0.9350 | 0.9190 | 0.9000 |
| σ | 1.2500 | 1.4000 | 1.7800 | 2.1700 | 2.8200 |

The following Table 2 presents the results of computations for five variations of Kₜ: 100, 200, 300, 400, and 500 for Cardiff-Weston with Wₐᵥₐ=3.019 km³/sec.

TABLE 2

| Kₜ | 100 | 200 | 300 | 400 | 500 |
|---|---|---|---|---|---|
| E_{ebb} | 48005.11 | 69847.80 | 80260.64 | 84145.21 | 84352.12 |
| [MWH] | | | | | |
| E_{tw} | 39129.40 | 73932.27 | 97100.69 | 110385.72 | 112788.36 |
| [MWH] | | | | | |
| Cₑ | 0.815 | 1.058 | 1.210 | 1.312 | 1.337 |
| W_{ebu} | 1.190 | 1.901 | 2.297 | 2.610 | 2.801 |
| [m³/sec] | | | | | |
| W_{twu} | 0.839 | 1.482 | 1.974 | 2.396 | 2.682 |
| [m³/sec] | | | | | |

Table 2 shows that E_{tw} grows faster than E_{ebb} as growth of Kₜ increases. Indeed, Cₑ=0.815 for Kₜ=100 and Cₑ=1.337 for Kₜ=500.

The explanation for this fact is as follows. For the ebb generation TPP (ETPP) the basin is filled up during flood via sluices located in main barrage, so for ETPP generation always begins at the highest value of basin elevation (Z_{b})ₘₐₓ. On the contrary for TWTPP claimed in Patent GB 2436857 during the flood the basin is filled exclusively via turbines and they are capable of filling the basin during the flood to level (Z_{b})_{fl.e} which is lower than (Z_{b})ₘₐₓ. For TWTPP ebb generation begins at (Z_{b})_{eb.b}=(Z_{b})_{fl.e}. So for TWTPP ebb always produces less energy than ebb for ETTP with the same turbines. The smaller Kₜ, the smaller the discharge capacity of the power house turbines and, therefore, smaller value of (Z_{b})_{fl.e} and the ebb generation energy output. As a result, the value of E_{ebb} is higher than E_{tw}. As Kₜ increases the discharge capacity of the plant grows leading to growth of Cₑ.

Finally Table 2 shows that the tidal plant according to the Patent GB 2436857 produces even less energy than the ebb generation plant with Kₜ=100. For Kₜ=200 (the value accepted for the Cardiff-Weston barrage) this two-way plant gives only 5.8% more energy than the ebb plant with an increase in capital investment for construction around 10% and, therefore, from an economical point of view is not acceptable. For Kₜ≧300 the increase in energy is not sufficient to overcome the increase of construction cost, because the power house represents the predominant expense which grows proportionally to Kₜ.

### BRIEF SUMMARY OF THE INVENTION

The present invention discloses a two-way generation tidal power plant which differs from the plant claimed in Patent GB 2436857 by crucial feature. Its main barrage is equipped with high discharge capacity bypasses, sluices participating in energy generation by means of discharging water in parallel with turbines during the final phases of ebb and flood generations.

These bypasses must have a discharge capacity up to 15 times greater than the discharge capacity of the power house turbines in order to substantially increase the daily energy output E and the water volume used for generation during each cycle Wᵤ comparing to the same values for the plant claimed in the Patent GB 2436857 with the same turbines.

Indeed, computations for Cardiff-Weston power house in UK equipped with turbines having Dₜ=7.5 m using my program ENERGY show the following result for number of turbines Kₜ=200:

The tidal plant claimed in the Patent GB 2436857 has E=73932.27 MWH and Wᵤ=1.482 km³

The tidal plant according to the present invention has E=96, 253.74 MWH and Wᵤ=2.596 km³

The increase in Wᵤ is very important from an environmental point of view. Indeed Wᵤ=2.596 km³ is very close to the available volume Wₐᵥₐ=3.019 km³ which is equal to the volume of water replaced during one cycle under natural conditions without a barrage.

### BRIEF DESCRIPTION OF THE SEVERAL VIEWS OF THE DRAWINGS

FIG. 1 is a schematic plan view of a two-way generation tidal power plant with bypasses participating in generation having a power house with one-way turbines, a main barrage and two additional barrages forming the head reservoir in the basin and the tail reservoirs in the outer bay;

FIG. 2 is a schematic plan view of a two-way generation tidal power plant with bypasses participating in generation shown in FIG. 1 during the initial phase of ebb generation when the head reservoir is connected to the basin, the tail reservoir is connected to the outer bay, and bypasses participating in generation, located in main barrage, are closed;

FIG. 3 is a schematic plan view of a two-way generation tidal power plant with bypasses participating in generation shown in FIG. 1 during the final phase of ebb generation when the head reservoir is connected to the basin, the tail reservoir is connected to the outer bay, and bypasses participating in generation, located in main barrage, are open and delivering the water from the basin to the outer bay in parallel with power house turbines;

FIG. 4 is a schematic plan view of a two-way generation tidal power plant with bypasses participating in generation shown in FIG. 1 during the initial phase of flood generation when the head reservoir is connected to the outer bay, the tail reservoir is connected to the basin, and bypasses participating in generation, located in main barrage, are closed;

FIG. 5 is a schematic plan view of a two-way generation tidal power plant with bypasses participating in generation shown in FIG. 1 during the final phase of ebb generation when the head reservoir is connected to the outer bay, the tail reservoir is connected to the basin, and bypasses participating in generation, located in main barrage, are open and delivering the water from the outer bay to the basin in parallel with power house turbines;

FIG. 6 is an elevation view, partially in cross-section, of a power house of a two-way generation tidal power plant with bypasses participating in generation equipped with Bulb turbines having mixed-flow runners and exit stay apparatuses.

### DETAILED DESCRIPTION OF THE INVENTION

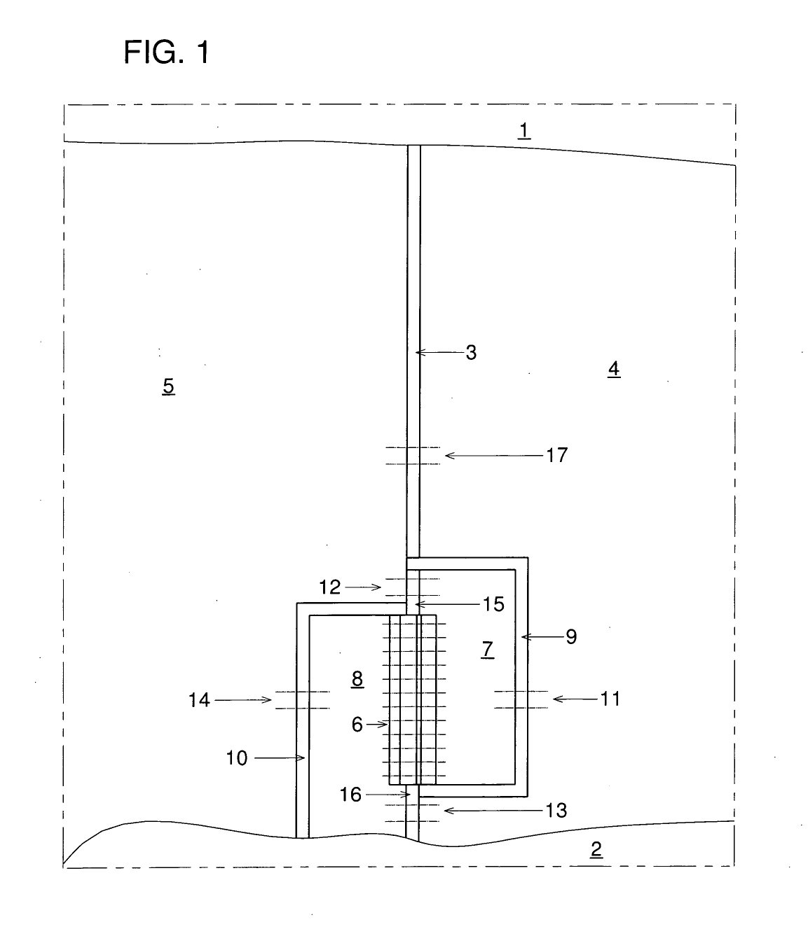

Referring now to FIG. 1, a two-way generation tidal power plant with bypasses participating in generation and with one-way turbines is shown. The tidal power plant comprises the main barrage 3 and the power house 6 with one-way turbines between the bay shores 1 and 2. The power house 6 is located at the shore 2. The head reservoir 8 is formed by the head barrage 10 located in the basin 5, the power house 6, a part of the main barrage 16 located between the power house 6 and the shore 2, and the shore 2 between the head barrage 10 and a part of the main barrage 16. The tail reservoir 7 is formed by the tail barrage 9 located in the outer bay 4, the power house 6, and a part of the main barrage 15 located between the power house 6 and the tail barrage 9. There are the following sets of sluices:

sluices 14 located at the head barrage 10 and connecting the head reservoir 8 with the basin 5,

sluices 13 located at the part of the main barrage 16 and connecting the head reservoir 8 with the outer bay 4,

sluices 11 located at the tail barrage 9 and connecting the tail reservoir 7 with the outer bay 4,

sluices 12 located at the part of the main barrage 15 and connecting the tail reservoir 7 with the basin 5,

bypasses 17 located at the part of the main barrage between shore 1 and the tail barrage 9 and connecting the basin 5 with the outer bay 4.

A two-way generation tidal power plant shown in FIG. 1 works in four different operating regimes: the initial ebb phase, the final ebb phase, the initial flood phase, and the final flood phase.

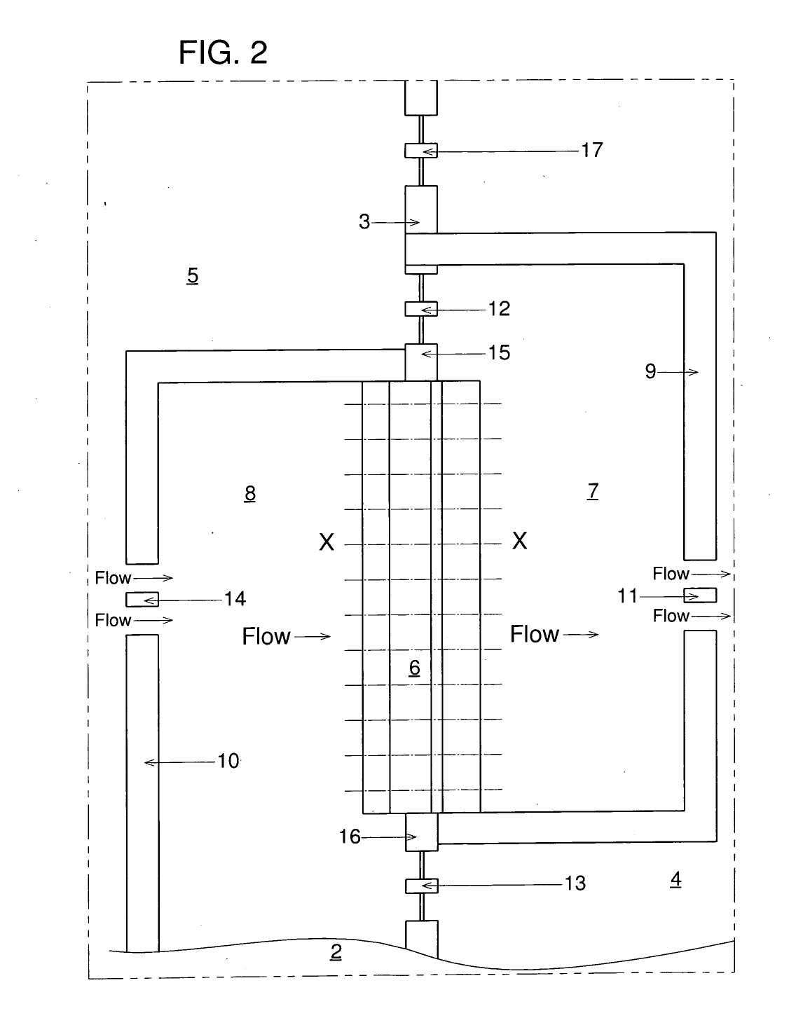

FIG. 2 shows a two-way generation tidal power plant with bypasses participating in generation and with one-way turbines during the initial ebb phase. As can be seen from this figure the flow from the basin 5 is passing via open sluices 14 to the head reservoir 8. After passing through the turbines of power house 6 to the tail reservoir 7 the flow finally passes to the outer bay 4 via sluices 11. Sluices 12 and 13 and the bypasses 17 are closed during this operating regime and, therefore, there is no water flow from the basin 5 to the outer bay 4 in parallel with the turbines of power house 6.

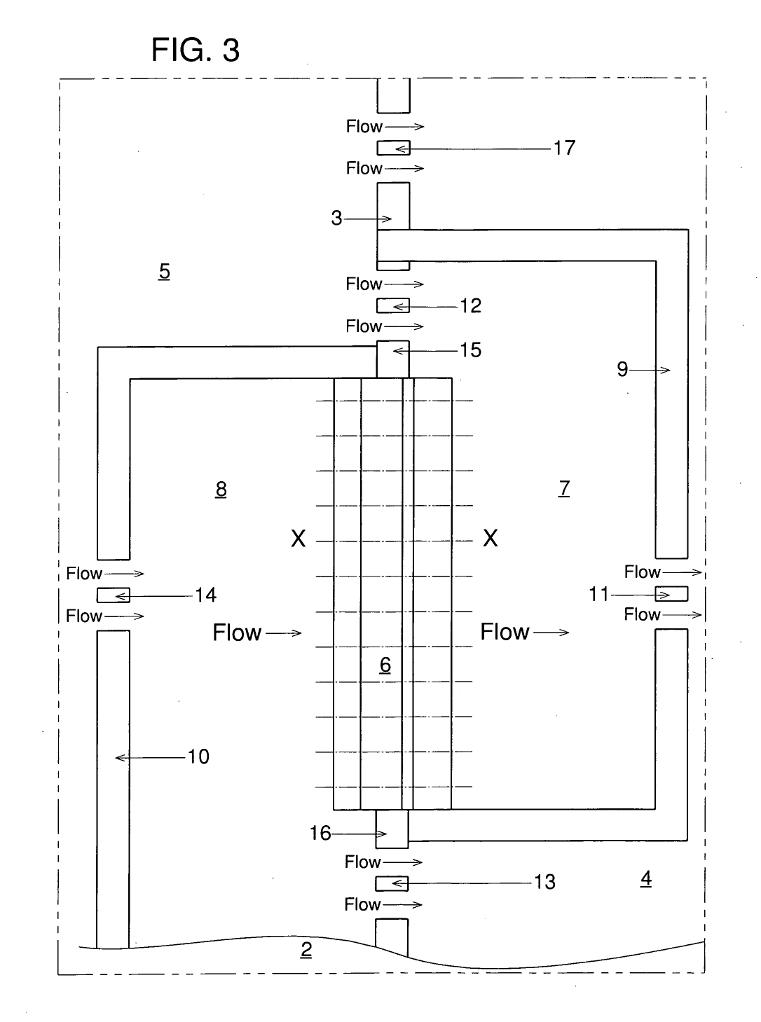

FIG. 3 shows a two-way generation tidal power plant with bypasses participating in generation and with one-way turbines during the final ebb phase. As can be seen from this figure the flow from the basin 5 allocated for power house 6, generating flow, passes via open sluices 14 to the head reservoir 8. After passing the turbines of power house 6 to the tail reservoir 7 the flow finally passes to the outer bay 4 via sluices 11. There is also water flow passing from the basin 5 to the outer bay 4 in parallel to the flow passing via power house 6, parallel flow. There are three parts to the parallel flow. The first part of the parallel flow is passing from the basin 5 to the outer bay 4 via bypasses 17. The second part of the parallel flow passes through the sluices 12 from the basin 5 to the tail reservoir 7 and from the tail reservoir 7 together with the generating flow to the outer bay 4. Finally the third part of the parallel flow passes through the sluices 14 from the basin 5 to the head reservoir 8 together with the generating flow and from head reservoir 8 the outer bay 4.

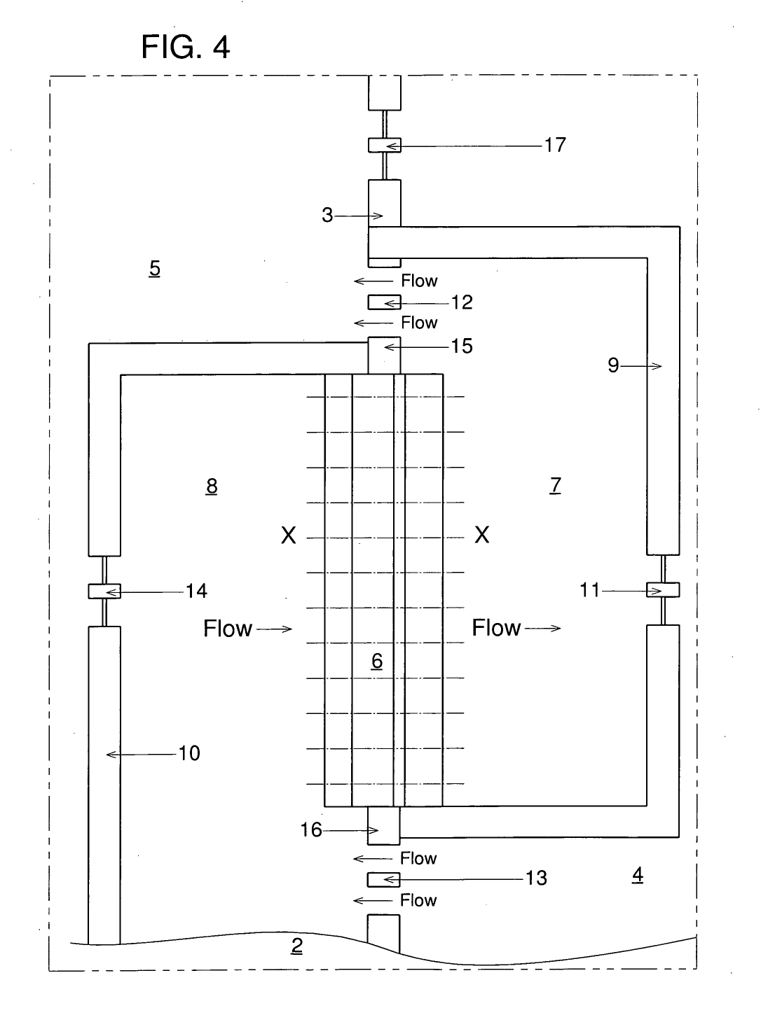

FIG. 4 shows a two-way generation tidal power plant with bypasses participating in generation and with one-way turbines during the initial flood phase. As can be seen from this figure. the flow from the outer bay 4 passes via open sluices 13 to the head reservoir 8. After passing the turbines of power house 6 to the tail reservoir 7 it finally passes to the basin 5 via sluices 12. Sluices 11 and 14 and bypasses 17 are closed during this operating regime and, therefore, there is no water flow from the outer bay 4 to the basin 5 in parallel with turbines of power house 6.

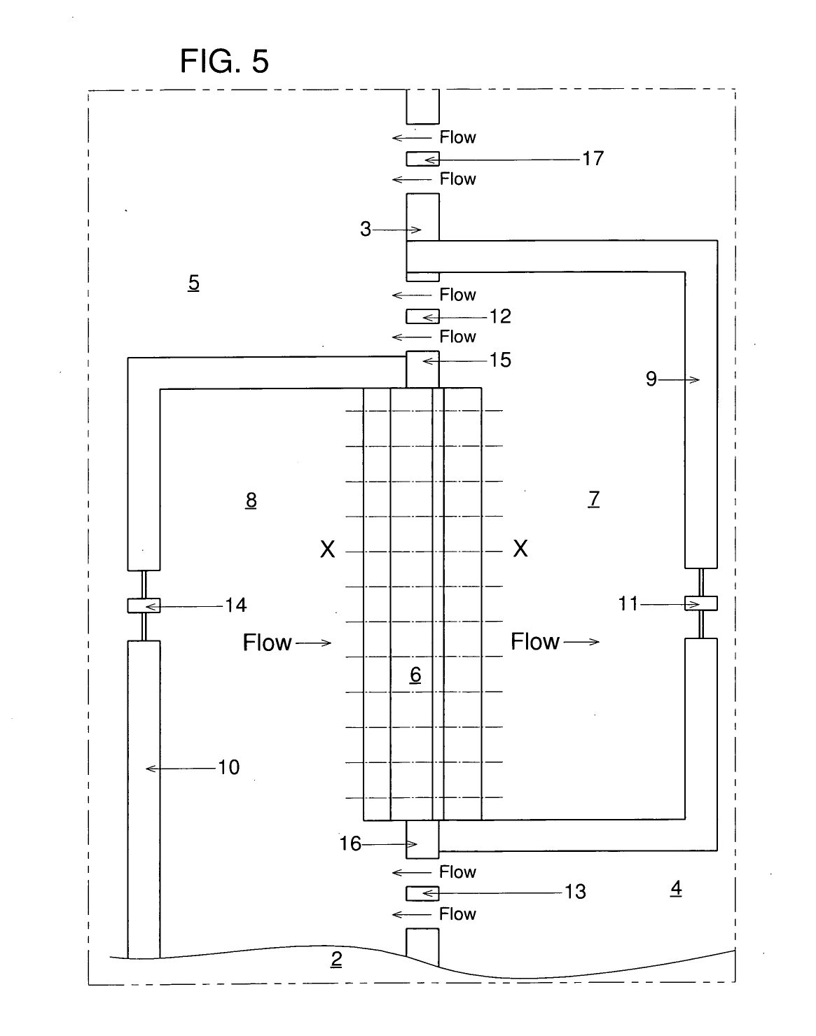

FIG. 5 shows a two-way generation tidal power plant with bypasses participating in generation and with one-way turbines during the final flood phase. As can be seen from this figure the flow from the outer bay 4 allocated for power house 6, generating flow, is passing via open sluices 13 to the head reservoir 8. After passing the turbines of power house 6 to the tail reservoir 7 it finally passes to the basin 5 via sluices 12. There is also flow from the outer bay 4 to the basin 5 via bypasses 17 in parallel to the flow passing via power house 6.

As presented above in Table 2 the increase of coefficient Cₑ comparing the daily output of two-way generation power plant with the daily output of ebb generation plant can be achieved by an increase of the discharge capacity of the plant by accepting a larger number of turbines, Kₜ, in the power house which causes a drastic increase in capital investment construction. In the present invention a substantial increase in the plant discharge capacity and, therefore, in Cₑ is achieved by bypassing the water in parallel with the power house turbines via sluices during ebb and flood final phases when the value of head, Hₜ, is relatively small. During the final flood phase bypasses 17 are used for this purpose. During the final ebb phase are used the bypasses 17, sluices 12 and 11, and sluices 14 and 13 for this purpose. The additional cost of construction of such a two-way tidal plant caused by the cost of bypasses 17 is much lower than the increase in the cost of the power house 6 due to the increase in Kₜ.

Bypasses 17 and other sluices 11, 12, 13 and 14 are vertical sliding gate sluices. Bypasses 17 have the following discharge capacity at one meter head:

(Q₁)_{bp}=K_{bp}C_{d}B_{bp}H_{bp}(2g)^{0.5} (5)

where:
K_{bp} is the number of bypasses,
C_{d} is the discharge coefficient,
B_{bp} is the aperture width of the bypass,
H_{bp} is the aperture height of the bypass, and
g is gravitational acceleration.

There are two evident constraints on the values of H_{bp} during ebb, (H_{bp})_{eb}, and the flood, (H_{bp})_{fl}, at any given time:

(Z_{b})_{eb}≧(Z_{cbpg})_{be}+(H_{bp})_{eb} (6)

(Zₜ)_{fl}≧(Z_{cbpg})_{be}+(H_{bp})_{fl} (7)

where:
(Z_{cbpg})_{be} is the bottom edge elevation of a closed bypass gate,
(Z_{b})_{eb} is the current water level in the basin during ebb, and
(Zₜ)_{fl} is the current water level of the ocean tide during flood.

The discharge capacity of bypasses 17, (Q₁)_{bp}, must be up to fifteen times higher than the discharge capacity of turbines in the power house 6, (Q₁)ₚₕ.

The reason for using sluices 12 and 11, and sluices 14 and 13 in addition to bypasses 17 during the ebb can be easily explained by the constraint (6) limiting the value of (H_{bp})_{eb}. Indeed, during the final ebb phase the value of (Z_{b})_{eb} is small and according to (6) (H_{bp})_{eb} must be smaller than the optimal value of the bypass aperture height, [(H_{bp})_{eb}]ₒₚ, required by the program ENERGY. On the contrary during the final flood phase the value of (Zₜ)_{fl} is big and [(H_{bp})_{fl}]ₒₚ always satisfies the constraint (7).

The use of bypasses 17 during the final flood phase and bypasses 17 together with sluices 11, 12, 13 and 14 during the final ebb phase substantially increases the energy output of the two-way tidal power plant and the water volume used for power generation per cycle. The computations by program ENERGY show that the two-way power plant with same turbines as shown in Table 1 and Table 2 with 200 units and with 200 bypasses 17 having B_{bp}=10 m will generate 96,253.74 MGH per diem. This is 1.30 times higher than the energy output of 73932.27 MGH presented in Table 2.

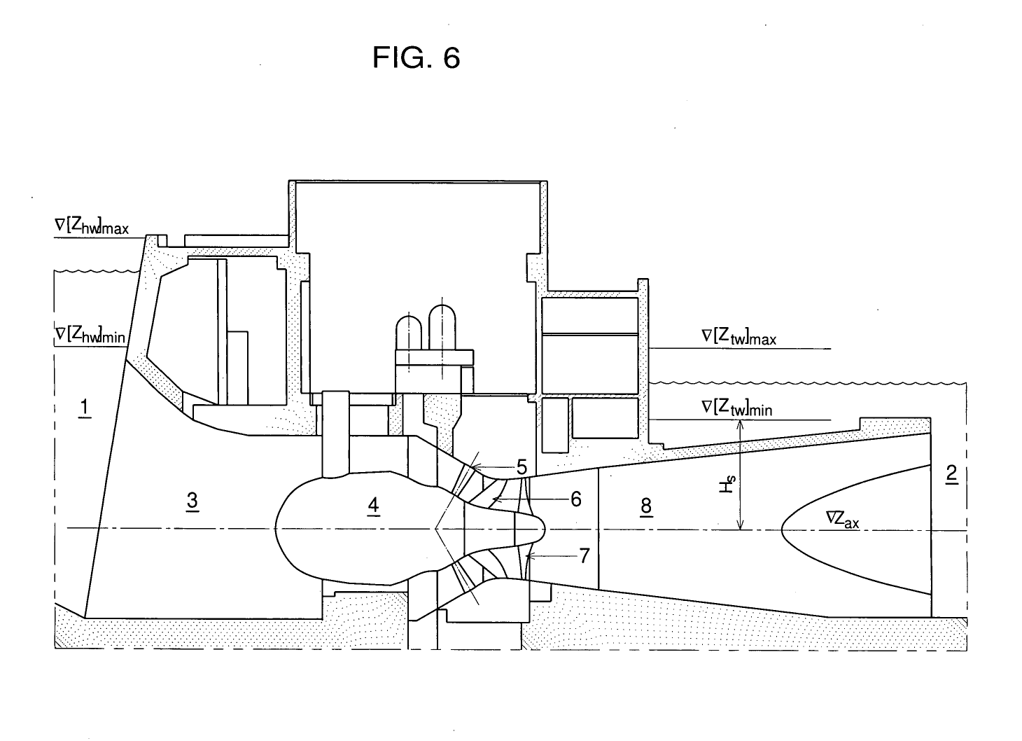

FIG. 6 shows an elevation view, partially in cross-section, of a power house of a barrage tidal power plant with a Bulb turbine having a mixed-flow propeller runner and an exit stay apparatus by a vertical plane X-X passing through a power house turbine axis in FIG. 2. This Bulb turbine with mixed-flow propeller runner was patented by me (“Hydraulic Bulb Turbine with Mixed-flow Propeller Runner”, U.S. patent application Ser. No. 12/386,011, Apr. 13, 2009, Applicant: Alexander Gokhman). I also have the patent on the exit stay apparatus (“Hydraulic Turbine and Exit Stay Apparatus therefor”, U.S. Pat. No. 6,918,744 B2, Jul. 19, 2005, Inventor: Alexander Gokhman).

The Bulb hydraulic turbine presented in FIG. 6 has an intake 3 connected with head water 1, a bulb 4 with a direct current generator inside, a conical distributor with diagonal wicket gates 5, a mixed-flow propeller runner 6, an exit stay apparatus 7, and a draft tube 8 connected with tail water 2. The Bulb turbine presented in FIG. 6 is different from the well known Bulb turbine for tidal power plants with a barrage, because it uses a mixed-flow propeller runner 6 instead of an axial flow propeller runner and also by having an exit stay apparatus 7 allowing the turbine to work at unit flow, Q₁₁, bigger than the optimal unit flow, (Q₁₁)ₒₚₜ, with high efficiency and small pressure pulsations in the draft tube 8. FIG. 6 shows the following levels:

∇[Z_{hw}]ₘₐₓ—the maximal head water level,

∇[Z_{hw}]ₘᵢₙ—the minimal head water level,

∇[Z_{tw}]ₘₐₓ—the maximal tail water level,

∇[Z_{tw}]ₘᵢₙ—the minimal tail water level,

∇[Zₐₓ]—the turbine axis level.

Also FIG. 6 shows the submergence of the turbine axis below the minimal tail water level, Hₛ=∇Zₐₓ−∇[Z_{tw}]ₘᵢₙ. FIG. 6 that Hₛ<0 and that with growth of its absolute value, |Hₛ|, the capital investment for the power house increases.

The use of a Bulb turbine with a mixed-flow propeller runner and an exit stay apparatus instead of the commercially available Bulb turbine with axial propeller and without an exit stay apparatus substantially increases the discharge capacity of the power house at one meter head without an increase of |Hₛ|, i.e. leads to substantial increase in the energy output without additional capital investment for construction.

I claim:

1. A two-way generation tidal power plant having a main barrage dividing the bay into the basin and the outer bay, a power house with hydraulic turbines connected to electrical generators, and bypasses taking part in power generation by passing in parallel with turbines the water from the basin to the outer bay during the ebb final phase and from the outer bay to the basin during the flood final phase.

2. A two-way generation tidal power plant in claim 1 wherein said bypasses are installed at main barrage.

3. A two-way generation tidal power plant in claim 2 wherein said bypasses are vertical sliding gate sluices and have the discharge capacity at one meter head, (Q₁)_{bp}, fifteen times higher than the discharge capacity at one meter head of said power house turbines, (Q₁)ₚₕ, wherein:
(Q₁)_{bp}=K_{bp}C_{d}B_{bp}H_{bp}(2g)^{0.5}
where:
K_{bp} is the number of bypasses,
C_{d} is the coefficient of discharge,
B_{bp} is the aperture width of the bypass,
H_{bp} is the aperture height of the bypass, and
g is gravitational acceleration,
and
(Q₁)ₚₕ=KₜDₜ²(Q₁₁)ₒₚ
where:
Kₜ is the number of turbines in power house,
Dₜ is the turbine runner diameter, and
(Q₁₁)ₒₚ is the turbine optimal specific flow rate.

4. A two-way generation tidal power plant in claim 3 wherein said power house is an integral part of said main barrage and is oriented along said main barrage and said hydraulic turbines having the water flowing in the same direction during both the ebb and the flood power generations.

5. A two-way generation tidal power plant in claim 4 comprising an additional head barrage located in the basin and an additional tail barrage located in the outer hay wherein:
said head barrage forming together with said power house and a part of said main barrage a head reservoir;
said tail barrage forming together with said power house and a part of said main barrage a tail reservoir;
said head barrage comprising delivering sluices admitting the water into said head reservoir from said basin during the ebb and closed during the flood generation;
said tail barrage comprising delivering sluices admitting the water into outer bay from said basin during the ebb and closed during the flood generation;
said parts of said main barrage between said power house and said tail and head barrages comprising sluices acting during the flood generation as delivering sluices admitting the water from the basin to said tail reservoir and from the outer bay to said head reservoir and during the ebb generation final phase acting as bypasses passing the water in parallel with power house turbines from the basin to the outer bay.

6. A two-way generation tidal power plant in claim 5 wherein said hydraulic turbines are bulb turbines having intake, guide gate apparatus, runner apparatus, and draft tube.

7. A two-way generation tidal power plant in claim 6 wherein said runner apparatus is mixed-flow runner.

8. A two-way generation tidal power plant in claim 7 wherein said bulb turbines having exit stay apparatus located in said draft tube after said mixed-flow runner.
